(19) United States
(12) Patent Application Publication
(10) Pub. No.: US 2015/0244702 A1
(43) Pub. Date: Aug. 27, 2015

(54) SYSTEMS AND METHODS FOR SHARING INFORMATION OVER A PRIVATE NETWORK

(71) Applicant: René NATHAN, (US)

(72) Inventor: René Nathan, Lower Templestowe (AU)

(21) Appl. No.: 14/431,201

(22) PCT Filed: Sep. 25, 2013
(86) PCT No.: PCT/AU2013/001097

§ 371 Date: Mar. 25, 2015

Related U.S. Application Data
(60) Provisional application No. 61/706,828, filed on Sep. 28, 2012.

(51) Int. Cl. H04L 29/06; G06F 17/30

(52) U.S. Cl. CPC H04L 63/083; G06F 17/30864

(57) ABSTRACT

There is provided a system for sharing information held by personnel within an organization, the system being implemented on a private computer network of the organization. The system has components including a database that connects to the private computer network. The database stores information (such as knowledge, skills and experience) held by personnel of the organization, and also the contact details of the personnel. Also included in the system are remote computers capable of connecting to the private computer network and a computer configured to search the database. The system allows a user of a remote computer to interrogate the database for a desired information, and where the desired information is held by one or more personnel the user of is presented with the name and/or contact details of the personnel holding the desired information.

### FIELD OF THE INVENTION

The present invention relates generally to the field of information management within organizations. In particular, the invention is directed to systems and methods to improve sharing of information held by individuals within an organization.

### BACKGROUND TO THE INVENTION

The so-called “silo effect” is a well documented problem of larger organizations. Put simply, organizational structures often act to inhibit the flow of information between discrete units within a business, and often even within discrete units. Indeed, it has been proposed that organizations are structured in such a way as to encourage the formation of silos. The manner in which heads within an organization are remunerated, the way in which they manage and report on their business financially, and they way in which key performance indicators are structured encourage a narrow focus. In some instances, silos can be formed or perpetuated deliberately by managers with a view to controlling information

While siloed organizational structures have some advantages in achieving commercial outcomes, negative outcomes are often an undesirable by-product. Restrictions in enterprise thinking, cultural diversity, collaboration, and innovation often result.

There are a number of factors that act to inhibit or prevent the dissemination of information within an organization. For example, embedded cultures may act to limit communication between personnel. Members of a department may tend to mix amongst themselves given their shared vocations, educational backgrounds, and knowledge base.

Geography is a further contributor to the general inhibition of information flow within an organization. Personnel spread across a number of locations do not have the same opportunity to interact as do co-workers housed in a single office building. Even where workers are in a single office, compartmentalization of information may still occur. For example, personnel working on different floors of a multi-storey building may have little or no need to visit another floor.

While communication platforms such as the telephone and email are always available, these means are not well used to disseminate information. These modes of communication generally rely on established networks, and are typically useful where two individuals have an existing relationship.

A further problem of the silo effect is that information is concentrated and retained by certain individuals in the capture of knowledge and experience within organizations. When personnel leave, often important information is irretrievably lost to the organization.

There have been attempts to address the problems of silos by the use of facilities analogous to social networking websites such as Facebook™. While allowing for some interaction between personnel in an organization, the solutions of the prior art have a number of shortcomings.

Prior art facilities typically facilitate interaction between individuals in existing networks, such as between staff in a certain location or department, or staff members that have previously met at a company conference. These arrangements do little to identify potentially useful contacts outside an individual's usual network. In addition, prior art facilities may fail to find an individual having a particular set of attributes even where that individual exists in the organization, and is active on the facility.

As mentioned, prior art facilities are based on social networking platforms. As a result, personnel tend toward using these facilities for social interactions within their established networks, leading to decreases in productivity. Many organizations are aware of the problems associated with social networking sites and ban access for personnel.

In addition to the above problems, prior art facilities also have security issues. Companies are typically very security conscious, and strive to keep information “in-house” as far as possible.

Another problem is that organizations are inherently undemocratic, with lower level personnel often not able to interact with higher level managers and executives.

It is an aspect of the present invention to alleviate or overcome one or more problems of the prior art by providing means for individuals within an organization to expand contact networks. From an organizational perspective, the invention seeks to provide a platform for the interchange of information between personnel with the aim of fostering cooperation, problem solving, and innovation.

The discussion of documents, acts, materials, devices, articles and the like is included in this specification solely for the purpose of providing a context for the present invention. It is not suggested or represented that any or all of these matters formed part of the prior art base or were common general knowledge in the field relevant to the present invention as it existed before the priority date of each claim of this application.

### SUMMARY OF THE INVENTION

In a first aspect, the present invention provides a system for sharing information held by personnel within an organization, the system being implemented on a private computer network of the organization, the system comprising:
(A) a database configured to connect the private computer network, the database comprising
   (i) information held by one or more personnel of the organization, and
   (ii) contact details of the one or more personnel; and
(B) one or more remote processor-enabled devices configured to connect to the private computer network, the one or more remote processor-enabled devices configured to search the database,
   wherein the system is configured to allow a user of the one or more remote processor-enabled devices to interrogate the database for a desired information, and where the desired information is held by one of the one or more personnel the user of the one-or more remote devices is/are presented with the name and/or contact details of the personnel holding the desired information.

In one embodiment the private network of the organization is configured such that it is not accessible by a processor-enabled device that is not owned, operated, controlled or administered by the organization.

In one embodiment the private network of the organization is implemented completely within a firewall of the organization.

In one embodiment the information held by the one or more personnel of the organization is obtained by a method which is at least partially controlled by the organization.

In one embodiment the method of obtaining information comprises presentation of the one or more personnel of the organization with a structured questionnaire.

In one embodiment the structured questionnaire is presented to the one or more personnel of the organization at the commencement of employment and/or at regular intervals during employment.

In one embodiment the structured questionnaire is structured by way of a set of predetermined questions.

In one embodiment one or more question(s) of the set of predetermined questions is presented with a set of multiple choice answers.

In one embodiment the information is not social-related information.

In one embodiment the system is configured such that the user(s) of the one or more remote processor-enabled devices must complete a log in step prior to grant of access to the database.

In one embodiment the system is configured such that the user(s) of the one or more remote processor-enabled devices are identifiable.

In one embodiment the system is configured such that the database is configured such that it is searchable for the information held by the one or more personnel by keyword(s).

In one embodiment the database is configured such that it is searchable for the information held by the one or more personnel by an explicit request for information, or in the form of a problem, a hypothetical scenario, or a case study.

In a second aspect the present invention provides a computer-implemented method for sharing information held by personnel within an organization, the method comprising the steps of obtaining information on one or more personnel of the organization, the information relating to a knowledge, skill or experience of the one or more personnel, entering the information into a database such that the name and/or contact details of the one or more personnel is linked to the relevant personnel's information, and optionally interrogating the database for a desired information, and where the desired information is held by one of the one or more personnel the name and/or contact details of the personnel holding the desired information is displayed.

In a third aspect, the present invention provides a database for accessing information held by one or more personnel within an organization, the database being operably connected to a private computer network of the organization, the database comprising:
(i) information held by one or more personnel of the organization, and
(ii) contact details and/or name(s) of the one or more personnel,
   wherein the information and contact details and/or names are linked.

### BRIEF DESCRIPTION OF THE DRAWING

FIG. 1 shows a block diagram showing a preferred embodiment of the system.

### DETAILED DESCRIPTION OF THE INVENTION

After considering this description it will be apparent to one skilled in the art how the invention is implemented in various alternative embodiments and alternative applications. However, although various embodiments of the present invention will be described herein, it is understood that these embodiments are presented by way of example only, and not limitation. As such, this description of various alternative embodiments should not be construed to limit the scope or breadth of the present invention. Furthermore, statements of advantages or other aspects apply to specific exemplary embodiments, and not necessarily to all embodiments covered by the claims.

Throughout the description and the claims of this specification the word “comprise” and variations of the word, such as “comprising” and “comprises” is not intended to exclude other additives, components, integers or steps.

Reference throughout this specification to “one embodiment” or “an embodiment” means that a particular feature, structure or characteristic described in connection with the embodiment is included in at least one embodiment of the present invention. Thus, appearances of the phrases “in one embodiment” or “in an embodiment” in various places throughout this specification are not necessarily all referring to the same embodiment, but may.

Applicant proposes that one or more problems of the prior art may be overcome or at least alleviated by providing means for personnel within an organization to exploit knowledge held by others within the same organization. Accordingly, in a first aspect, the present invention provides a system for sharing information held by personnel within an organization, the system being implemented on a private computer network of the organization, the system comprising: (A) a database configured to connect to the private computer network, the database comprising (i) information held by one or more personnel of the organization, and (ii) contact details of the one or more personnel; and (B) one or more remote processor-enabled devices configured to connect to the private computer network, the one or more remote processor-enabled devices configured to search the database, wherein the system is configured to allow a user of the one or more remote processor-enabled devices to interrogate the database for a desired information, and where the desired information is held by one of the one or more personnel the user of the one-or more remote devices is/are presented with name and/or contact details of the personnel holding the desired information.

The present invention is a significant advance on prior art methods of personnel interaction within organizations. Applicant proposes that the present systems may unlock the significant reservoirs of information held by personnel for the exploitation of others in the same organization, with a view to advancing the organization in some commercial aspect. Importantly, this sharing of information is achieved in a secure manner. Furthermore, the information may be procured and disseminated in a controlled manner where the system providing the organization with administrative powers.

As used herein, the term “information” is intended to be construed broadly to include any knowledge, skill, or experience that may be held by personnel. In one embodiment, the information does not include simple data. For example, company-administered data that is searchable and/or accessible to some or all personnel (or at least a subset of personnel) is not included in some embodiments. Examples of company-administered data include sales data, Gantt charts, production schedules, marketing materials, and the like.

In one embodiment, the information is information that is not normally available to all personnel of the organization, or at least not normally available to a subset of personnel. While project teams within an organization may be availed of computer-based means to search for information held by team members, this information may only be available to team members. The information may well be potentially useful by personnel outside the project team but is not searchable or available to members of other project teams. Similarly, the information may only be normally available to personnel on a particular floor within an office, at a particular geographical location, or at a certain level of seniority. In some embodiments, the present invention overcomes these barriers to allow for the sharing of information across an organization.

In one embodiment, the information relates to matters that the organization would prefer to keep confidential, or must keep confidential. For example, where the organization is a pharmaceutical company it may be deleterious (legally or commercially) for the company to allow personnel to exchange information on production issues, or negative clinical trial results in an unsecure manner.

The information may extend to matters such as particular work-related problems or issues that personnel are facing or have faced, or particular work-related interests of the individual. The personnel information may relate to any of knowledge, skill, experience, current and past work-related problems, current and past work-related issues, current and past work-related ideas. The personnel information may relate to previous organizations, current role, responsibilities, group level, work-related interests, work-related likes, work-related dislikes, and language fluency.

As used herein, the term “private network” is intended to mean a computer network that is configured to decline access to individuals outside the organization. In one embodiment, the network is not accessible to the internet except by way of password, biometric contrivance, or other security mechanism. In one embodiment of the system the private network of the organization is configured such that it is not accessible by a processor-enabled device that is not owned, operated, controlled or administered by the organization. In one embodiment, the private network of the organization is implemented completely within a firewall of the organization.

As used herein, the term “personnel” is intended to be construed broadly to include one or more of the following: one or more full-time employees, part-time employees, contractors, consultants, and volunteers.

As used herein, the term “organization” is intended to be construed broadly to mean any collection or individuals in the pursuit of one or more common goals. The organization may be for profit or not-for-profit, privately owned, publicly owned, or a government organization. Preferably, the organization is a commercial organization for profit. Given the problem of silos in larger commercial organizations, the invention is particularly applicable to organizations having at least about 100, 200, 300, 400, 500, 600, 700, 800, 900, 1000, 2000, 3000, 4000, 5000, 6000, 7000, 8000, 9000, 10000, 15000, 20000, 25000, 30000, 35000, 40000, 45000, 50000, 60000, 70000, 80000, 90000, 100000, 110000, 120000, 130000, 140000, 150000, 160000, 170000, 180000, 190000 and 200000 personnel. Preferably, the organization has at least about 50000, more preferably more than about 100000 personnel. Greater advantages are proposed for very large organizations given the very significant problems of silos in such establishments. It is considered that for very large organizations to problems of silos are virtually insurmountable by those inside and outside the organizations, and so use of the present invention can provide unexpected advantages.

In some embodiments, the organization has less than about 5000000, 4000000, 3000000, 2000000 or 1000000 personnel.

A significant advantage of the present systems results from the structured nature of the information held by the database. Prior art facilities which are based on social networking platforms allow users to freely enter information, but they are just as free to not enter information that may be important to the organization. Accordingly, any database incorporated into prior art facilities will be incomplete and/or difficult to search.

The structured nature of the information of the present systems may arise from the information being obtained from personnel by a method which is at least partially controlled by the organization. Intervention by the organization is proposed to increase the completeness and/or reliability of the information held in the database. This approach is in direct contrast to prior art facilities which allow personnel to control what type of information to enter, as well as the quality of information that is entered.

The method of obtaining information may comprise presentation of the one or more personnel of the organization with a structured questionnaire. The questionnaire may be administered to the one or more personnel in any convenient format. In one embodiment the structure questionnaire is presented to personnel in the course of an interview, for example during an induction process. A member of the human resources department may pose a series of predetermined questions in order to increase the likelihood of eliciting information which may be of use to the organization.

More typically, the structured questionnaire is presented to personnel in the context of a web browser, or similar format. Entry of information can be elicited in a highly structured manner, with the answer to a question directing subsequent line(s) of questioning. As an example, a first question may relate to the skills in which a marketing professional has practical expertise: internet; television, print media, or radio. Where the answer is “internet” a specific group of sub-questions will be posed, requesting whether the internet marketing expertise is in the field of web page design, content, analytics, running alternative campaigns etc. Such sub-questions will be irrelevant to a marketer having experience only in print media, for example. It is proposed that this method of guided questioning can result in superior quality of information given that personnel can more fully respond to only more relevant questions.

The method of obtaining information from the one or more personnel of the organization may be computer-implemented, and optionally incorporated into the present systems.

In one embodiment, the structured questionnaire is presented to the one or more personnel of the organization at the commencement of employment and/or at regular intervals during employment. The system may comprise means for automatically forwarding reminder correspondence to personnel (such as by email) in a periodic manner, prompting personnel to update information.

The nature of the predetermined questions may, to some extent, rely on the particular type of organization. For example, where the organization is an information technology organization the predetermined questions may relate predominantly to the types of operating systems, computer languages, wireless data transfer protocols, or database architectures in which the personnel has detailed knowledge.

As another example, where the organization is a recruitment organization the predetermined questions may relate predominantly to identifying and capturing existing or ongoing client relationships which may be exploitable by the organization, any industry sub-sectors in which the personnel is particularly familiar, or experience in organizing displays at employment fairs.

It will be appreciated that the examples provided herein may be trivial in nature, however the skilled artisan is amply enabled to decide on a predetermined set of questions useful for the industry sector of a particular organization.

In one embodiment, the one or more question(s) of the set of predetermined questions is presented with a set of multiple choice answers. It is proposed that significant advantage is obtained given that highly structured (and therefore easily searchable) information is generated where personnel have only a limited number of options from which to select in answering a predetermined question.

As an example, where the organization is a professional legal services organization a predetermined question may relate to litigation experience, and more particularly the litigation areas in which the personnel has experience. The multiple choice answers to that question could be selected from the following:
Litigation strategy
Pre-trial discovery
Pre-trail mediation
Briefing expert witnesses
Briefing counsel
Drafting claims and counterclaims
Damages assessment
Media relations during trial

The multiple choice answers may be provided, by way of selection on a printed page, by drop-down menu or radio buttons on a browser page, or verbally during interview.

It will be understood that while some embodiments of the present systems comprise structured methods of eliciting information from personnel, unstructured means (such as inviting the user to enter “free-text”) are not precluded. Indeed, some predetermined question may not be amenable to structures means.

Preferably, the information obtained and retained by the present systems is not predominantly social-related information. In one embodiment, the information is less than about 50%, 45%, 40%, 35%, 30%, 25%, 20%, 15%, 10% or 5% social-related information. As used herein, the term “social-related information” is intended to mean information that does not apply to work. Social-related information broadly includes information relating to hobbies, interests, personal relationships, sports, family life, entertainment, and the like. It will be understood that the definition of social-related information may vary according to the industry in which the organization is involved. For example, while information relating to clothing fashions would constitute social related information where the organization is an engineering company this would not be the case where the organization is a fashion magazine.

The present systems are configured to allow a user of the one or more remote processor-enabled devices to interrogate the database for a desired information. By this configuration, a user is enabled to search for knowledge, skills or experience held by personnel of the organization with the aim of dealing with a business problem, or other matter such as identification of personnel having the skills required to fill another position within the organization. As mentioned supra, the use of predetermined questions (and optionally in multiple choice format) aids in the generation of a rigorously searchable database. Alternatively, the database may be searched by personnel name in order for management (and possibly others in the organization) to review the skills, experience and knowledge held by a particular individual.

The database may be searchable keywords and/or attributes of a record; by knowledge, skills, experience, past employers, geography, or even business-related issues and ideas posted by personnel for general viewing across the organization. The database may be searchable to identify cohorts having shared attributes or keywords.

In one embodiment, the system is configured such that when searching the user is presented with a descending numerical counter which is automatically activated as inclusion of keywords gradually tightens and pinpoints the search. There may be a rewarding outcome of this embodiment which encourages the user to be more focused in their use of keywords. Adding relevant keywords terms gives the user the satisfaction of seeing his or her search narrowing toward the personnel sought.

In one embodiment of the systems, the search terms are selectable by drop down menus or radio buttons. Typically, the selections of the menus or buttons are the same as those used when information was entered into the database. The consistency in usage of terms may lead to increasing the chance of identifying individuals having a given attribute. In prior art facilities using free-text as basis for entry and searching of databases it is proposed that a significant number of “matches” will be missed. For example, US-based personnel within a paper products organization may enter in the system expertise in the field of “diaper manufacture”, while an Australian user may search the database for expertise in “nappy manufacture”. The Australian user will not be provided with contact details for the US-based personnel because of the disparity in terms used for infant absorbent products.

It is contemplated that the present systems may be useful in referring business opportunities to one or more personnel in an organization. For example, a sales enquiry may be received by a initial contact person not in the relevant business unit of the organization. That person may utilize the present systems to identify personnel able to assist the enquirer. The search may identify a number of relevant personnel, each of whom would be desirous of assisting with a view to securing a sale from the enquirer. The system may be configured to allow the initial contact person to dispatch emails to each person identified as potentially relevant to the enquiry. In one embodiment, the first person to respond is rewarded with the contact details of the enquirer while others are disqualified at first instance.

The present systems may be configured to utilize the position descriptions of all personnel as a source of information relating to the experience and knowledge of personnel. In some embodiments, the position description information is the primary source of information (or at least a highly weighted source of information), which may be supplemented by other information sources such as that inputted by individuals. It is proposed that position description information may be a more reliable indicator of experience and knowledge held by an individual, as compared with other sources.

The present systems may be configured to search current and previous positions held by the member of an organisation by reference to position description, rather than a title. This provides an organisation with the ability to track the evolution of a member's skills, experience and knowledge over time and hence make a more accurate assessment of the value of a member against current business requirements.

Furthermore, when an individual assumes a new position within an organization, the position description attached to that individual in a human resources database will change upon their commencement in the new position. This approach ensures that information searchable for an individual is current, and lessens the chance that a search identifies individuals based on outdated information.

Some embodiments of the system are configured to provide real-time (or near real-time) reporting on the activity of new and established connections between individuals within an organisation in response to changes in organisational strategy. This reporting (typically viewed by senior management of the organization) provides longitudinal insight into the effectiveness of internal marketing and communication, as well as into who the influencers are for a given strategic shift.

As required by the present system, the user of the one-or more processor-enabled remote devices is/are presented with the name and/or contact details of the personnel holding the desired information. The term “processor” refers to any device or portion of a device that processes electronic data, e.g., from registers and/or memory to transform that electronic data into other electronic data that, e.g., may be stored in registers and/or memory.

A requirement of a remote device is the ability to convey the desired information in a user-comprehensible form. While the device may convey the name and/or contact details of the relevant personnel by video, audio, graphical or paper means, more conveniently the information is provided as text on the screen of the device. To that end, the remote device may be a personal computer, a smart phone, a tablet, a net book, a note book, or a lap top.

The database of the present systems may be of any type capable of performing the functions described herein. Generally, the database is of the relational type, such as Advantage Database Server, Altibase, Apache Derby, Cubrid, Datacom, DB2, Drizzle, Empress Embedded Database, FileMaker, Firebird, HSQLDB, H2, Informix Dynamic Server, Ingres, InterBase, LucidDB, MAriaDB, MaxDB, Microsoft Access, FoxPro, Microsoft SQL Server, MonetDB/SQL, mSQL, Nexusdb, Omnis Studio, OpenLink Virtuoso, Oracle, Oracle, Rdb, Paradox, Peoplesoft, Pervasive PSQL, Polyhedra DBMS, Postgre SQL, RDM embedded, RDM server, SAP, ScimoreDB, smalISQL, SQL Anywhere, SQL Base, SQLite, Unidata and Xeround Cloud Database.

In a preferred form of the system, the database is based on data or a physical database that is ordinarily in place in the organization. Human resources departments typically obtain and retain personnel data such as name, address, date of birth, current office location, current position description, email address and the like. The present systems add an overlay of information in the form of personnel skills, knowledge and experience to the basic human resources data normally held by an organization. Larger organizations typically utilize Oracle, SAP or Microsoft SQL PeopleSoft and therefore the present systems are preferably configured so as to incorporate into these database types.

Conveniently, although not exclusively, the front end interface of the system is implemented in the form of a web browser or similar contrivance. Such embodiments are preferred given the familiarity of browser interfaces to many individuals. Although browsers are primarily intended to use the World Wide Web, they can also be used to access information provided by web servers in private networks or files in file systems. The major web browsers are familiar to the skilled artisan, including Firefox, Chrome, Internet Explorer, Opera, and Safari.

The private network of the present systems may be implemented by wired means, such as twisted pair wire, computer networking cabling (wired Ethernet as defined by IEEE 802.3), coaxial cable, ITU-T G.hn technology, optical fiber. The term “wired” and its derivatives may be used to describe circuits, devices, systems, methods, techniques, communications channels, etc., that may communicate data through the use of modulated electromagnetic radiation through a solid medium.

In addition or alternatively the network may be implemented by wireless means including terrestrial microwave, communications satellite, cellular and PCS systems, radio and spread spectrum technologies such the IEE 802.11 protocols. In the context of this document, the term “wireless” and its derivatives may be used to describe circuits, devices, systems, methods, techniques, communications channels, etc., that may communicate data through the use of modulated electromagnetic radiation through a non-solid medium.

The network may implement any suitable communications protocol including an ethernet protocol, TCP/IP (including IPv4 and IPv6), Synchronous Optical Networking (SONET) and Synchronous Digital Hierarchy (SDH).

Then network may be implemented at any desired scale including personal area network, local area network, storage area network, campus area network, backbone network, metropolitan area network, wide area network, enterprise private network, virtual private network, virtual network, or internetwork. A preferred embodiment is that of the enterprise private network given the enhanced security available.

As mentioned supra, a preferred embodiment of the system is implemented partially or completely within a firewall of the organization. The firewall may be either software-based or hardware-based (or a combination). The firewall may operate by network layer or packet filter, application layer, proxy, or network address translation.

In another aspect the present invention provides a computer readable medium comprising information as described herein, linked to the name and/or contact details of the personnel. The medium may be in the form of random access memory, magnetic hard drive, optical medium, or SSID for example. Preferably, the computer readable medium is managed as a relational database.

One embodiment of the systems and methods described herein is in the form of a computer-readable carrier medium carrying a set of instructions, e.g., a computer program for execution on one or more processors. Thus, as will be appreciated by those skilled in the art, embodiments of the present invention may be embodied as a method, an apparatus such as a special purpose apparatus, an apparatus such as a data processing system, or a computer-readable carrier medium. The computer-readable carrier medium carries computer readable code including a set of instructions that when executed on one or more processors cause a processor or processors to implement a method as described herein. Accordingly, aspects of the present invention may take the form of a method, an entirely hardware embodiment, an entirely software embodiment or an embodiment combining software and hardware aspects. Furthermore, the present invention may take the form of carrier medium (e.g., a computer program product on a computer-readable storage medium) carrying computer-readable program code embodied in the medium.

The information may be transmitted or received over a network via a network interface device. While the carrier medium is shown in an example embodiment to be a single medium, the term “carrier medium” should be taken to include a single medium or multiple media (e.g., a centralized or distributed database, and/or associated caches and servers). The term “carrier medium” shall also be taken to include any medium that is capable of storing, encoding or carrying a set of instructions for execution by one or more of the processors and that cause the one or more processors to perform any one or more of the methodologies of the present invention. A carrier medium may take many forms, including but not limited to, non-volatile media, volatile media, and transmission media.

It will be understood that the steps of methods discussed are performed in one embodiment by an appropriate processor (or processors) of a processing (i.e., computer) system executing instructions (computer-readable code) stored in storage. It will also be understood that the invention is not limited to any particular implementation or programming technique and that the invention may be implemented using any appropriate techniques for implementing the functionality described herein. The invention is not limited to any particular programming language or operating system.

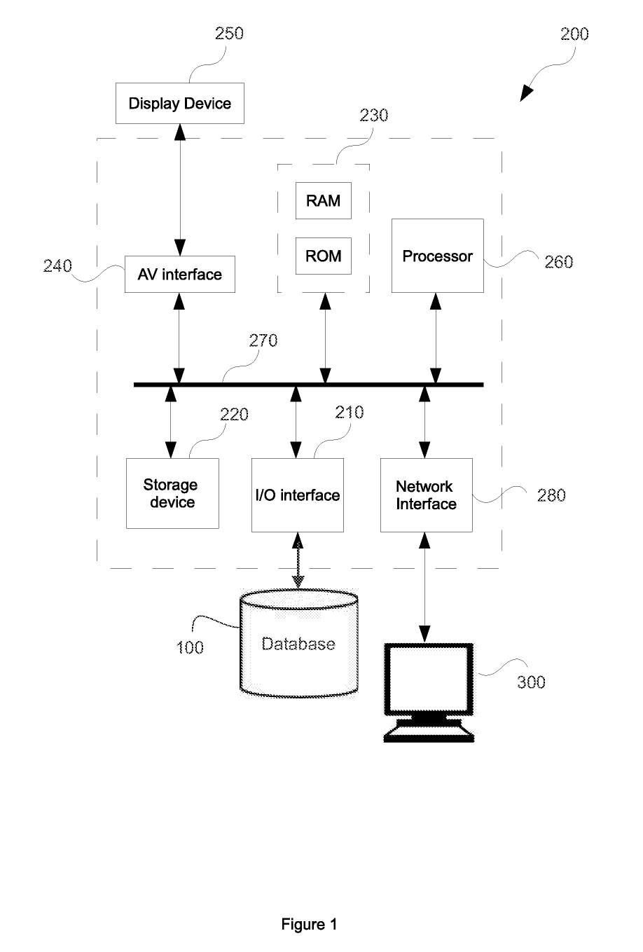

Reference is now made to FIG. 1 which is a block diagram showing a preferred embodiment of the system comprising a central database 100 having a plurality of records, each record having information on knowledge, skills and expertise held by organizational personnel. The database is operably connected to a central computer 200 via an I/O interface 210, the computer having a local storage device 220 and memory 230 having computer-executable instructions for executing the computer-executed actions required, an AV interface 240 operably connected to a display device 250, and a processor 260, all operably connected to a communications bus 270. The system includes a remote computer 300 which is operably connected to the central computer 200 via a network interface 280. Both central computer 200 and remote computer 300 are disposed within a firewall of the organization.

In another aspect the present invention provides a computer-implemented method for sharing information held by personnel within an organization, the method comprising the steps of obtaining information on one or more personnel of the organization, the information relating to a knowledge, skill or experience of the one or more personnel, entering the information into a database such that the name and/or contact details of the one or more personnel is linked to the relevant personnel's information, and optionally interrogating the database for a desired information, and where the desired information is held by one of the one or more personnel the name and/or contact details of the personnel holding the desired information is displayed.

In one embodiment the structured questionnaire is presented to the one or more personnel of the organization at the commencement of employment and/or at regular intervals during employment.

In one embodiment the structured questionnaire is structured by way of a set of predetermined questions.

In one embodiment, one or more question(s) of the set of predetermined questions is presented with a set of multiple choice answers.

In one embodiment the information is not social-related information.

In one embodiment the method includes the step of a user completing a log in step prior to grant of access to the database.

In one embodiment, a user is identifiable.

In one embodiment the database is configured such that it is searchable for the information held by the one or more personnel by keyword(s).

In one embodiment the database is configured such that it is searchable for the information held by the one or more personnel information by an explicit request for information, or in the form of a problem, a hypothetical scenario, or a case study.

In one embodiment, the method comprises use of a system described herein.

In a further aspect the present invention provides a database for accessing information held by one or more personnel within an organization, the database being operably connected to a private computer network of the organization, the database comprising: (i) information held by one or more personnel of the organization, and (ii) contact details and/or name(s) of the one or more personnel, wherein the information and contact details and/or names are linked.

The present invention is proposed to be useful in collecting and retaining the collective knowledge, skills and experience of personnel in an organization. Where information is sought by way of computer-based forums detailing a problem, issue or idea such exchanges between users can be retained for future reference. These exchanges can be useful in data mining to problem solve similar problems, address similar issues or advance similar ideas at a later date. The information may also be mined by senior management of an organization with the aim of identifying particularly innovative or knowledgeable employees, or suitable candidates for vacancies in an organization.

Furthermore, some of the embodiments are described herein as a method or combination of elements of a method that can be implemented by a processor of a processor device, computer system, or by other means of carrying out the function. Thus, a processor with the necessary instructions for carrying out such a method or element of a method forms a means for carrying out the method or element of a method. Furthermore, an element described herein of an apparatus embodiment is an example of a means for carrying out the function performed by the element for the purpose of carrying out the invention.

It will be appreciated that in the description of exemplary embodiments of the invention, various features of the invention are sometimes grouped together in a single embodiment, figure, or description thereof for the purpose of streamlining the disclosure and aiding in the understanding of one or more of the various inventive aspects. This method of disclosure, however, is not to be interpreted as reflecting an intention that the claimed invention requires more features than are expressly recited in each claim. Rather, as the following claims reflect, inventive aspects lie in less than all features of a single foregoing disclosed embodiment. Thus, the claims following are hereby expressly incorporated into this Summary section, with each claim standing on its own as a separate embodiment of this invention.

Furthermore, while some embodiments described herein include some but not other features included in other embodiments, combinations of features of different embodiments are meant to be within the scope of the invention, and form different embodiments, as would be understood by those in the art. For example, in the following claims, any of the claimed embodiments can be used in any combination.

In the description provided herein, numerous specific details are set forth. However, it is understood that embodiments of the invention may be practiced without these specific details. In other instances, well-known methods, structures and techniques have not been shown in detail in order not to obscure an understanding of this description.

Thus, while there has been described what are believed to be the preferred embodiments of the invention, those skilled in the art will recognize that other and further modifications may be made thereto without departing from the spirit of the invention, and it is intended to claim all such changes and modifications as fall within the scope of the invention. Functionality may be added or deleted from the block diagrams and operations may be interchanged among functional blocks. Steps may be added or deleted to methods described within the scope of the present invention.

Although the invention has been described with reference to specific examples, it will be appreciated by those skilled in the art that the invention may be embodied in many other forms.

The present invention will now be more fully described by reference to the following non-limiting examples.

### Example 1

### Employee Recruitment—Database Entries

A multinational pharmaceutical corporation having in excess of 80,000 personnel recruits a new full-time employee. Upon commencement, human resource officer enters the following data relating to the new employee into a database:

| FIELD | ENTRY |
|---|---|
| Name: | DOE, John |
| Home Address | 21 Elm Street, Metropolis, CA. |
| Citizenship | United States |
| Qualification(s) | Bachelor of Science (Biochemistry) |
| Position | Research and Development Scientist |
| Current Salary | USD85,000.00 |
| Next Salary Review | May 2013 |
| Work Physical Address | Laboratory 5.05, level 5, R&D complex |
| Work email address | jdoe@pharmacompany.com |
| Work telephone number | +1 6975 5670 |
| Work Skype address | jdoe.pharmacompany |

In addition, the human resources officer (or authorised personnel) enters data that has been obtained from the new employee by way of structured interview.

| FIELD | ENTRY |
|---|---|
| Previous organization(s) | World Wide Therapeutics, Inc |
| (entered by free text) | |
| Previous position(s) | Process scale up validation scientist; regulatory affairs |
| (entered by free text) | associate |
| Language skills | French (technical) |
| (selected by drop down menu) | |
| Technical skills | Chromatography, protein purification, bioassay |
| (selected by drop down menu) | development |
| Business Skills | Negotiations on bulk supply of chromatographic media |
| (entered by free text) | |
| Other skills | Practical mechanical engineering skills obtained while |
| (entered by free text) | process validation scientist; including machining |
| | stainless steel fittings for use in pilot scale up work. |

The data is entered by the human resources officer (or authorised personnel) into a Microsoft SQL database hosted on the company's enterprise network. The data is entered by way of a web browser interface.

### Example 2

### Searching Employee Database for Personnel Haying Predetermined Skill Set

A production manager in France is faced with a problem of increasing production volume, and has hit a problem with finding stainless steel fittings for a custom made chromatography column. The issue is commercially sensitive because a production problem may lead to a competitor informing the market about potential supply problems.

The production manager has no person with the relevant scientific, engineering and regulatory skills. The manager has had meetings with representatives of the French R&D team, process scale up team, and regulatory affairs team but has not found a solution.

The manager interrogates the database with the following keywords:
“process”
“scale up”
“stainless”
“fitting”
“regulatory”
“French”

In response, the database returns all database details for John Doe, except for salary details. The production manager contacts John Doe via Skype to discuss his problem. John's fluency in technical French leads to a number of suggestions.

Before contacting John Doe, the production manager is not aware that his company has engineering expertise. This is normally contracted to external providers on a case-by-case basis.

### Example 3

### Employee Updating Skills

After 12 months employment, an automatically generated email reminder prompts John Doe to update details on his knowledge, skills and experience. He logs into the system by way of a dedicated browser-based front end to review his information. He is not permitted to change any field, except for the following:
Language skills
Technical skills
Business Skills
Other skills

John amends the “other skills” field to include specific engineering outcomes devised in assisting in finding a solution to the French production manager's problem. He also been studying Spanish at a community college after work, and has added “Spanish (rudimentary)” to the language skills field.

1. A system for sharing information held by personnel within an organization, the system being implemented on a private computer network of the organization, the system comprising:
(A) a database configured to connect the private computer network, the database comprising
(i) information held by one or more personnel of the organization, and
(ii) contact details of the one or more personnel; and
(B) one or more remote processor-enabled devices configured to connect to the private computer network, the one or more remote processor-enabled devices configured to search the database,
wherein the system is configured to allow a user of the one or more remote processor-enabled devices to interrogate the database for a desired information, and where the desired information is held by one of the one or more personnel the user of the one-or more remote devices is/are presented with the name and/or contact details of the personnel holding the desired information.

2. The system of claim 1 wherein the private network of the organization is configured such that it is not accessible by a processor-enabled device that is not owned, operated, controlled or administered by the organization.

3. The system of claim 1 wherein the private network of the organization is implemented completely within a firewall of the organization.

4. The system of claim 1 wherein the information held by the one or more personnel of the organization is obtained by a method which is at least partially controlled by the organization.

5. The system of claim 1 wherein the method of obtaining information comprises presentation of the one or more personnel of the organization with a structured questionnaire.

6. The system of claim 1 wherein the structured questionnaire is presented to the one or more personnel of the organization at the commencement of employment and/or at regular intervals during employment.

7. The system of claim 5 wherein the structured questionnaire is structured by way of a set of predetermined questions.

8. The system of claim 7 wherein one or more question(s) of the set of predetermined questions is presented with a set of multiple choice answers.

9. The system of claim 1 wherein the information is not social-related information.

10. The system of any claim 1 configured such that the user(s) of the one or more remote processor-enabled devices must complete a log in step prior to grant of access to the database.

11. The system of claim 1 configured such that the user(s) of the one or more remote processor-enabled devices are identifiable.

12. The system of claim 1 configured such that the database is configured such that it is searchable for the information held by the one or more personnel by keyword(s).

13. The system of claim 1 wherein the database is configured such that it is searchable for the information held by the one or more personnel by an explicit request for information, or in the form of a problem, a hypothetical scenario, or a case study.

14. A computer-implemented method for sharing information held by personnel within an organization, the method comprising the steps of obtaining information on one or more personnel of the organization, the information relating to a knowledge, skill or experience of the one or more personnel, entering the information into a database such that the name and/or contact details of the one or more personnel is linked to the relevant personnel's information, and optionally interrogating the database for a desired information, and where the desired information is held by one of the one or more personnel the name and/or contact details of the personnel holding the desired information is displayed.

15. A database for accessing information held by one or more personnel within an organization, the database being operably connected to a private computer network of the organization, the database comprising:
(i) information held by one or more personnel of the organization, and
(ii) contact details and/or name(s) of the one or more personnel,
wherein the information and contact details and/or names are linked.
